(19) United States
(12) Patent Application Publication
(10) Pub. No.: US 2007/0034725 A1
(43) Pub. Date: Feb. 15, 2007

(54) CD shredder

(76) Inventor: Yann-Chiou Duh, Shin Chuang City (TW)

Correspondence Address: PRO-TECHTOR INTERNATIONAL SERVICES, 20775 NORADA CT., SARATOGA, CA, 95070, US

(21) Appl. No.: 11/199,868

(22) Filed: Aug. 9, 2005

(51) Int. Cl. B02C 18/16

(52) U.S. Cl. 241/236

(57) ABSTRACT

Disclosed is a CD shredder, which includes a housing having an elongated insertion slot at the top, a pair of circular cutters arranged inside the housing for shredding a waste CD into pieces, a cover pivoted to the housing and turnable between a horizontal position and a vertical position to close/open the elongated insertion slot, torsional springs that support the cover in the open position, and a spring-supported retainer for locking the cover in the close position.

### BACKGROUND OF THE INVENTION

1. Field of the Invention:

The present invention relates to a machine for shredding waste CD (compact disk) and more particularly, to a CD shredder, which is easy and convenient to operate and has means to prohibit shredded waste chips from jumping out of the CD shredder to hurt the user.

2. Description of the Related Art:

Waste CDs (compact disks) must be properly disposed of to prevent damage to the environment. People usually will use a heavy crusher or tool to crush waste CDs. Because these tools are heavy and expensive, not everybody can afford.

### SUMMARY OF THE INVENTION

The present invention has been accomplished under the circumstances in view. It is therefore the main object of the present invention to provide a CD shredder, which is compact and convenient to operate. It is another object of the present invention to provide a CD shredder, which is safe in use.

According to one aspect of the present invention, the CD shredder comprises a housing, the housing having a top wall, an elongated insertion slot cut through the top wall, a semicircular top recess formed in the top wall at one side of the elongated insertion slot, and an arched groove formed in the top wall and extended from the periphery of the semicircular top recess; a pair of circular cutters respectively pivotally mounted inside the housing and arranged in a staggered manner for shredding a waste compact disk being inserted into the elongated insertion slot; a semicircular cover pivoted to the housing and turnable relative to the housing between a vertical position to open the elongated insertion slot and a horizontal position to close the elongated insertion slot, the semicircular cover having two bottom lugs symmetrically disposed at two sides, and two pivot pins respectively inserted through the bottom lugs to pivotally secure the semicircular cover to the housing; two torsional springs respectively mounted on the pivot pins and respectively connected between the bottom lugs of the semicircular cover and the housing to hold the semicircular cover in the vertical position; a retainer mounted in the arched groove of the housing and supported on a spring member in the arched groove and adapted to hold the semicircular cover in the horizontal position, the retainer being released from the semicircular cover for enabling the semicircular cover to be biased by the torsional springs to the vertical position when the retainer is pressed by the user. According to another aspect of the present invention, the semicircular cover has parallel lines of bristles at the bottom side for stopping shredded waste chips from jumping out of the elongated insertion slot to hurt the user accidentally during the operation of the CD shredder.

### BRIEF DESCRIPTION OF THE DRAWINGS

FIG. 1 is an elevational view of a CD shredder according to the present invention.

FIG. 2 is an exploded view of the CD shredder according to the present invention.

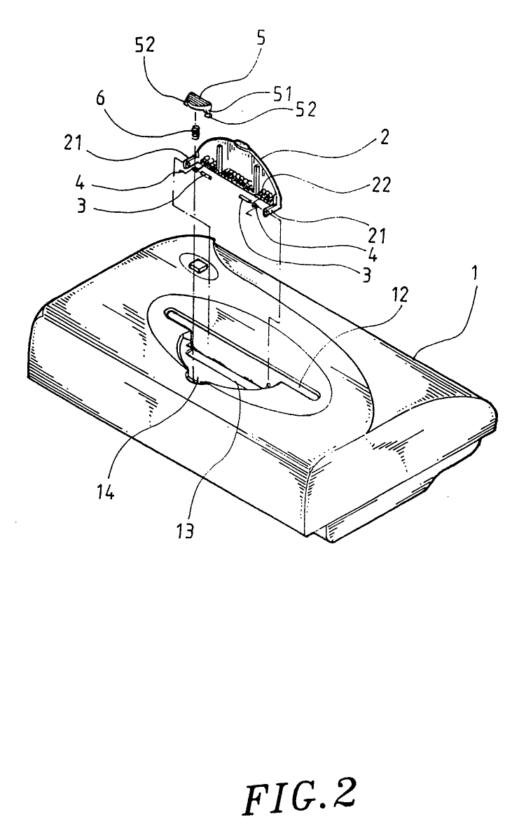

FIG. 3 is an enlarged view of a part of FIG. 2.

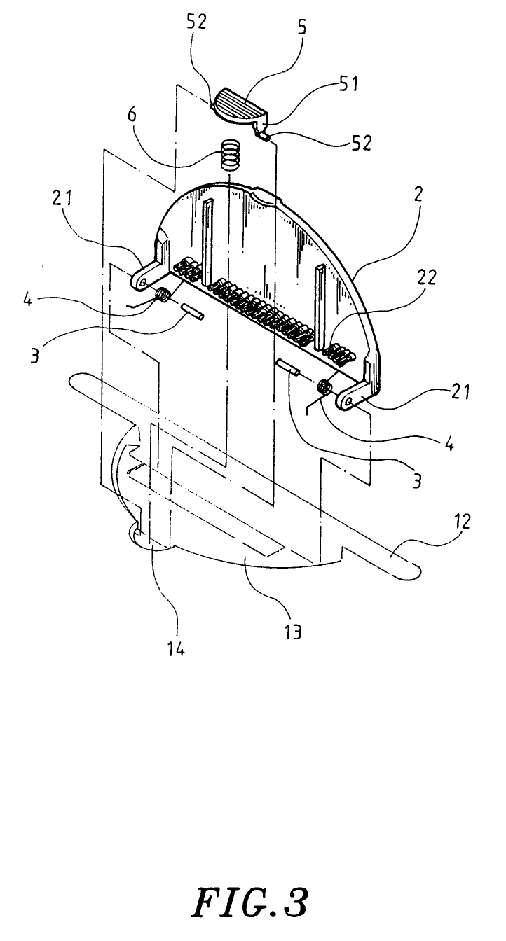

FIG. 4 is a sectional side view of the CD shredder according to the present invention.

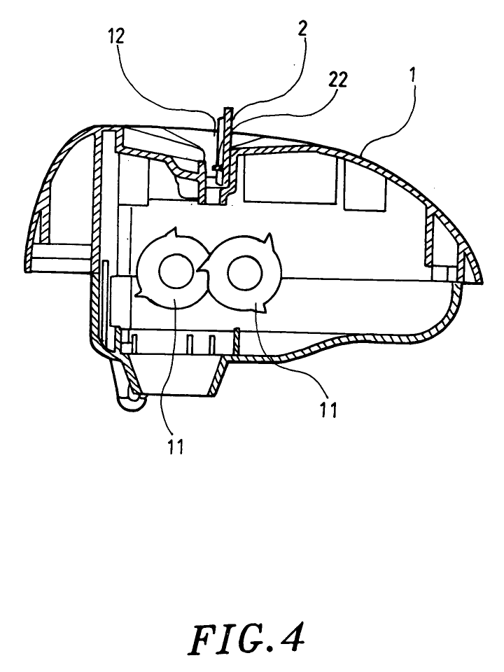

FIG. 5 shows a status of use of the CD shredder according to the present invention.

FIG. 6 is a sectional side view of FIG. 5.

### DETAILED DESCRIPTION OF THE PREFERRED EMBODIMENT

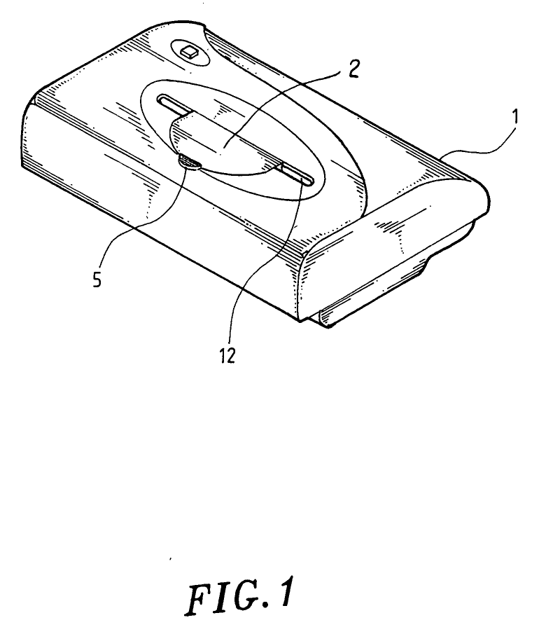

Referring to FIGS. 1˜4, a CD shredder in accordance with the present invention is shown comprising a housing 11. The housing 11 has an elongated insertion slot 12 cut through the top wall thereof, a semicircular top recess 13 formed in the top wall at one side of the elongated insertion slot 12, and an arched groove 14 formed in the top wall and extended from the midpoint of the periphery of the semicircular top recess 13. A pair of circular cutters 11 are respectively pivotally mounted inside the housing 11 and arranged in a staggered manner for shredding an inserted CD (compact disk) or sheets of paper into pieces. A semicircular cover 2 is coupled to the housing 11 to prohibit insertion of a CD into the elongated insertion slot 12. The cover 2 has two bottom lugs 21 symmetrically disposed at two sides, and parallel lines of bristles 22 fastened to the bottom wall. Pivot pins 3 are respectively inserted through the bottom lugs 21 and fastened to the housing 1 near the elongated insertion slot 12 to pivotally secure the cover 2 to the semicircular top recess 13 of the housing 1. Two torsional springs 4 are respectively mounted on the pivot pins 3 and respectively connected between the bottom lugs 21 and the housing 1, imparting a biasing force to the cover 2. Therefore, the cover 2 can be turned relative to the housing 1 between a vertical position where the elongated insertion slot 12 is fully opened for the insertion of a CD, and a horizontal position where the cover 2 is received in the semicircular top recess 13 and has a part projecting into the elongated insertion slot 12 to prohibit insertion of a CD into the elongated insertion slot 12. Further, the torsional springs 4 impart a biasing force the cover 2, holding the cover 2 in the vertical position. Further, a retainer 5 is mounted in the arched groove 14 and supported on a compression spring 6 to hold the cover 2 in the horizontal position. The retainer 5 has two vertical bottom lugs 51 and two horizontal round pins 52 respectively outwardly extending from the vertical bottom lugs 51 at right angles and respectively pivotally connected to the peripheral wall of the arched groove 14. Normally, the retainer 5 holds down the cover 2 in the horizontal position to close the elongated insertion slot 12. When the user pressed the retainer 5, the retainer 5 is disengaged from the cover 2, and the torsional springs 4 immediately bias the cover 2 from the horizontal position to the vertical position to open the elongated insertion slot 12 for the insertion of a CD into the housing 1 for cutting by the circular cutters 11.

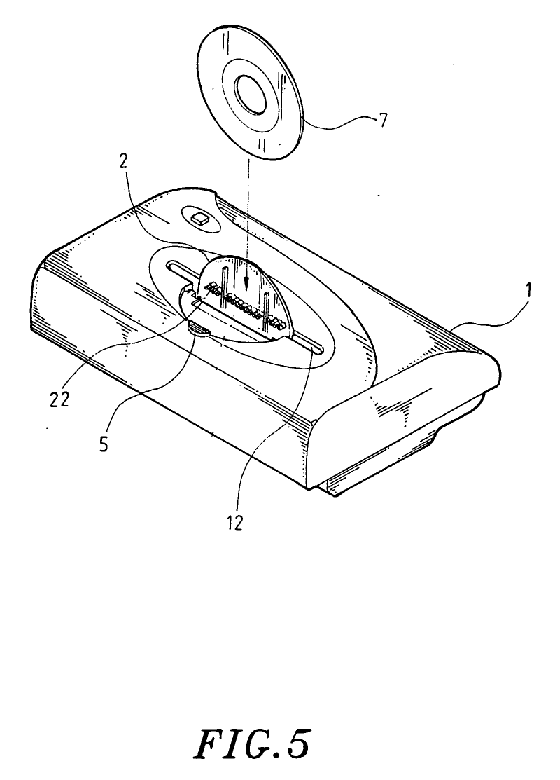

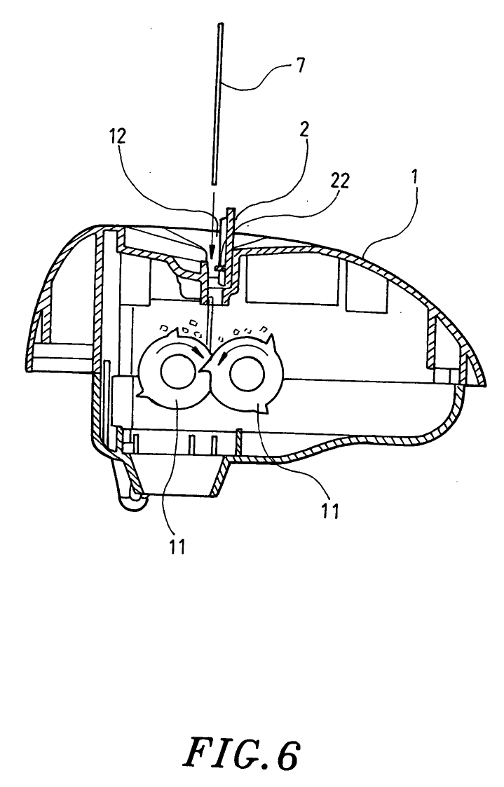

Referring to FIGS. 5 and 6, when the user pressed the retainer 5 to release the cover 2, the cover 2 is biased by the torsional springs 4 to the vertical position to open the elongated insertion slot 12. At this time, the user can insert the waste CD 7 into the elongated insertion slot 12 for shredding into pieces by the circular cutters 12. During shredding, the bristles 22 stop waste chips from jumping out of the elongated insertion slot 12. Further, because the cover 2 protrudes over the top side of the elongated insertion slot 12, it prohibits insertion of the user's finger into the elongated insertion slot 12 accidentally.

In addition to shredding CDs, the invention can also be used as a paper shredder for shredding paper. Further, plastic baffle means or any of a variety of other guard means may be used to substitute for the bristles 22.

A prototype of CD shredder has been constructed with the features of FIGS. 1˜6. The CD shredder functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A CD shredder comprising.
a housing, said housing having a top wall, an elongated insertion slot cut through said top wall, a semicircular top recess formed in said top wall at one side of said elongated insertion slot, and an arched groove formed in said top wall and extended from the periphery of said semicircular top recess;
a pair of circular cutters respectively pivotally mounted inside said housing and arranged in a staggered manner for shredding a waste compact disk being inserted into said elongated insertion slot;
a semicircular cover pivoted to said housing and turnable relative to said housing between a vertical position to open said elongated insertion slot and a horizontal position to close said elongated insertion slot, said semicircular cover having two bottom lugs symmetrically disposed at two sides, and two pivot pins respectively inserted through said bottom lugs to pivotally secure said semicircular cover to said housing;
two torsional springs respectively mounted on said pivot pins and respectively connected between said bottom lugs of said semicircular cover and said housing to hold said semicircular cover in said vertical position;
a retainer mounted in said arched groove of said housing and supported on a spring member in said arched groove and adapted to hold said semicircular cover in said horizontal position, said retainer being released from said semicircular cover for enabling said semicircular cover to be biased by said torsional springs to said vertical position when said retainer is pressed by the user.

2. The CD shredder as claimed in claim 1, wherein said semicircular cover has baffle means adapted to stop shredded waste chips from jumping out of said elongated insertion slot during the operation of the CD shredder.

3. The CD shredder as claimed in claim 1, wherein said baffle means comprises parallel lines of bristles arranged at a bottom side of said semicircular cover.
